(19) United States
(12) Patent Application Publication
(10) Pub. No.: US 2007/0043981 A1
(43) Pub. Date: Feb. 22, 2007

(54) Methods and devices for detecting and isolating serial bus faults

(75) Inventors: Yi Chang Wu, Taipei Hsien (TW); Yi Hsun Chen, Taipei Hsien (TW); Sen Ta Chan, Taipei Hsien (TW)

Correspondence Address: QUINTERO LAW OFFICE, PC, 2210 MAIN STREET, SUITE 200, SANTA MONICA, CA, 90405, US

(73) Assignee: WISTRON CORP., TAIPEI HSIEN (TW)

(21) Appl. No.: 11/297,533

(22) Filed: Dec. 7, 2005

(30) Foreign Application Priority Data
Aug. 19, 2005 (TW) TW94128370

(51) Int. Cl. G06F 11/00

(52) U.S. Cl. 714/49

(57) ABSTRACT

A method for detecting and isolating serial bus faults. Whether any bus fault has occurred on a serial bus coupled to a device through an isolator is detected. When a bus fault occurs on the serial bus, the isolator is controlled to isolate the device from the serial bus. Whether the device fails is then determined. When the device does not fail, the isolator is controlled to couple the device to the serial bus. When the device fails, an alert is issued, and the isolation of the devicecontinues.

### BACKGROUND

The invention relates to computer techniques, and in particular, to methods and devices for detecting and isolating serial bus faults.

Serial transmission is increasingly implemented in point to point or point to multipoint wired transmission due to better noise tolerance thereof. Universal serial Bus (USB), IEEE 1394 (FireWire), PCI express bus, and serial advanced technology attachment (SATA) bus are examples of serial buses. Some bus specifications, such as inter-integrated circuit (I²C) and system management bus (SMBus or SMB), even supports multi-master frameworks. Stability in serial transmission is currently an important issue. With reference to FIG. 1, in some serial transmission configurations, a transmission line (such as bus 100) connects all devices (such as devices 101-103) in series. Thus, if a device fails, the device may affect other devices and block data transmission on the line. The device causing the bus fault, however, is hard to locate.

Current serial transmission configurations can discover bus failure and provide alerts accordingly, but cannot handle device faults. If a bus fault occurs on an important circuit, even bus failure alerts cannot be issued.

### SUMMARY

Accordingly, methods and devices for detecting and isolating serial bus faults are provided.

An exemplary embodiment of a method for detecting and isolating serial bus faults comprises the following steps. A fault is detected on a serial bus. A plurality of devices are respectively coupled to the serial bus through different isolators. When a bus fault occurs on the serial bus, the devices are isolated from the serial bus utilizing the isolators. Each of the devices is tested. When a first device of the devices is non-faulty, an isolator is controlled to couple the first device to the serial bus. When the first device is faulty, an alert is issued, and the first device remains isolated.

An exemplary embodiment of a device for detecting and isolating serial bus faults comprises a communication interface, a detector, a controller, and a test unit. The communication interface coupled to a serial bus through an isolator receives or transmits data therethrough. The detector coupled to the serial bus determines if any bus fault has occurred on the serial bus. The controller is coupled to the detector and the isolator. When a bus fault occurs on the serial bus, the controller automatically isolates the device from the serial bus utilizing the isolator. The test unit coupled to the controller tests the device. When the device is non-faulty, the controller couples the device to the serial bus utilizing the isolator. When the device is faulty, the controller keeps isolating the device.

An exemplary embodiment of a device for detecting and isolating serial bus faults comprises a detector, a controller, and a test unit. The detector coupled to a serial bus determines if any bus fault has occurred on the serial bus to which a plurality of devices are respectively coupled through different isolators. The controller is coupled to the detector and the isolators. When a bus fault occurs on the serial bus, the controller automatically isolates the devices from the serial bus utilizing the isolators. The test unit coupled to the controller tests each of the devices. When a first device of the devices is non-faulty, the controller couples the first device to the serial bus utilizing an isolator. When the first device is faulty, the controller keeps isolating the first device.

### DESCRIPTION OF THE DRAWINGS

The invention can be more fully understood by reading the subsequent detailed description and examples with references made to the accompanying drawings, wherein:

FIG. 1 is a schematic diagram of the configuration of a conventional serial bus;

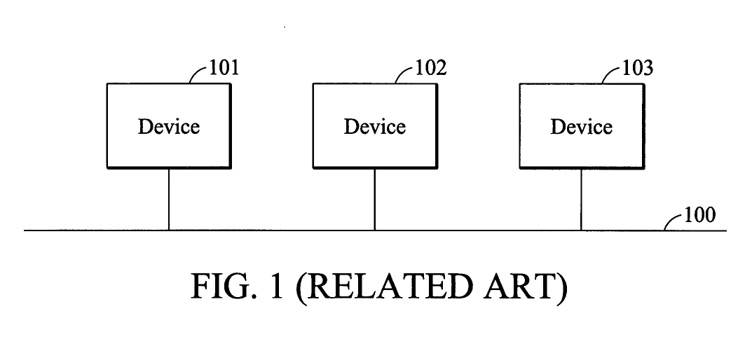

FIG. 2 is a schematic diagram of a serial bus and a first embodiment of a device for detecting and isolating serial bus faults;

FIG. 3 is flowchart of a first embodiment of a method for detecting and isolating serial bus faults;

FIG. 4 is a schematic diagram of a serial bus and a second embodiment of a device for detecting and isolating serial bus faults; and

FIG. 5 is flowchart of a second embodiment of a method for detecting and isolating serial bus faults.

### DETAILED DESCRIPTION

Methods and devices for detecting and isolating serial bus faults are provided. Note that entities, steps, and configurations thereof described in the following are only examples and can be adjusted according to real requirements.

### First Embodiment

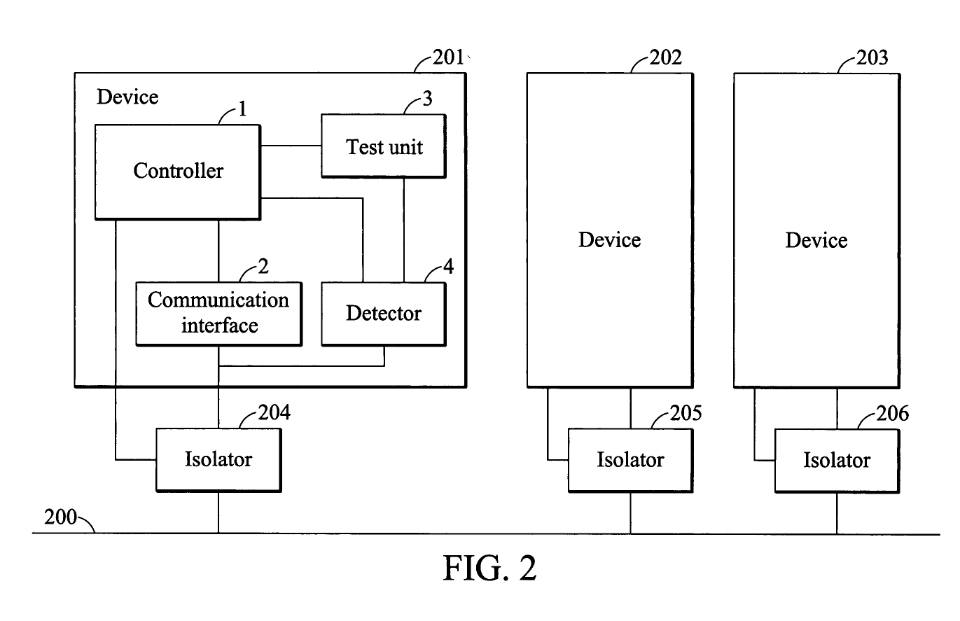

Serial bus 200 in FIG. 2 is coupled to communication interfaces of devices 201-203 through isolators 204-206. Device 201-203 receives or transmits signals through their communication interfaces. Isolators 204-206 can isolate devices 201-203 from serial bus 200 or couple them. Serial bus 200 may conform to I2C, SMBus, IEEE 1394, or other serial bus specifications. Isolators 204-206 may be implemented by reel relays, electromagnetic relays, a solid state relays, transistors, bi-directional buffers, optical isolators, or others. The optical isolators may comprise photo couplers and phototransistors.

In FIG. 2, device 201 for detecting and isolating serial bus faults comprises controller 1, communication interface 2, test unit 3, and detector 4.

Serving as the interface between device 201 and serial bus 200, communication interface 2 is coupled to serial bus 200 through isolator 204, and receives or transmits data therethrough. Detector 4 coupled to serial bus 200 through isolator 204 determines if any bus fault has occurred on serial bus 200. Controller 1 coupled to communication interface 2, test unit 3, detector 4, and the isolator 204.

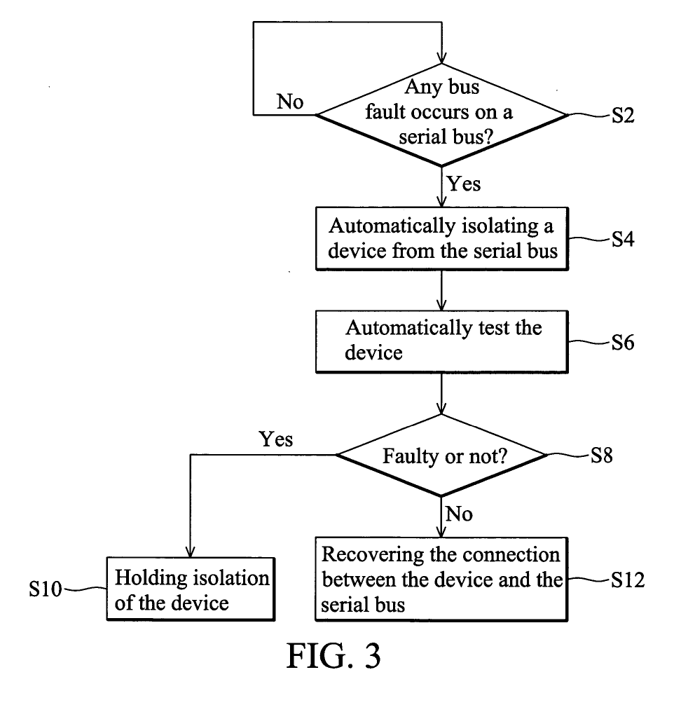

With reference to FIG. 3, detector 4 determines if any bus fault has occurred on serial bus 200 (step S2). Bus fault detection schemes may be altered according to bus specifications. The typical status of a serial bus may be classified as “bus free” or “bus busy”. The “bus free” status indicates that no device is utilizing the bus, and the bus voltage may either stay high or low. The “bus busy” status indicates that at least one device is utilizing the bus for data transmission, and the bus voltage may continuously alternate between high and low. When alternating beyond these two statuses, serial bus 200 is considered to have faults. For example, the voltage of serial bus 200 is designed to stay high when in the “bus free” status. Serial bus 200 is considered faulty when the voltage thereon stays low. On the contrary, if serial bus 200 is designed to have the voltage thereon stay low when in the “bus free” status, serial bus 200 is considered faulty when the voltage thereon stays high. Thus, bus fault detection schemes may vary with bus specifications.

When a bus fault occurs on serial bus 200, controller 1 automatically isolates device 201 from serial bus 200 utilizing isolator 204 (step S4). Thus, device 201 cannot transmit or receive signals through serial bus 200.

After device 201 is isolated from serial bus 200, test unit 3 automatically tests device 201 (step S6) and determines whether device 201 is faulty or not based on the test results (step S8). When device 201 is non-faulty, controller 1 couples device 201 to serial bus 200 utilizing isolator 204 (step S10). When device 201 is faulty, controller 1 directs isolator 204 to keep device 201 isolated (step S12). Device 201 may be further removed from serial bus 200.

Devices 202 and 203 may act as device 201 to detect bus faults, perform self-isolation, self-test, and recover connections to serial bus 200 or remain isolated. The following second embodiment can be utilized when devices on a serial bus lack self-test capabilities.

### Second Embodiment

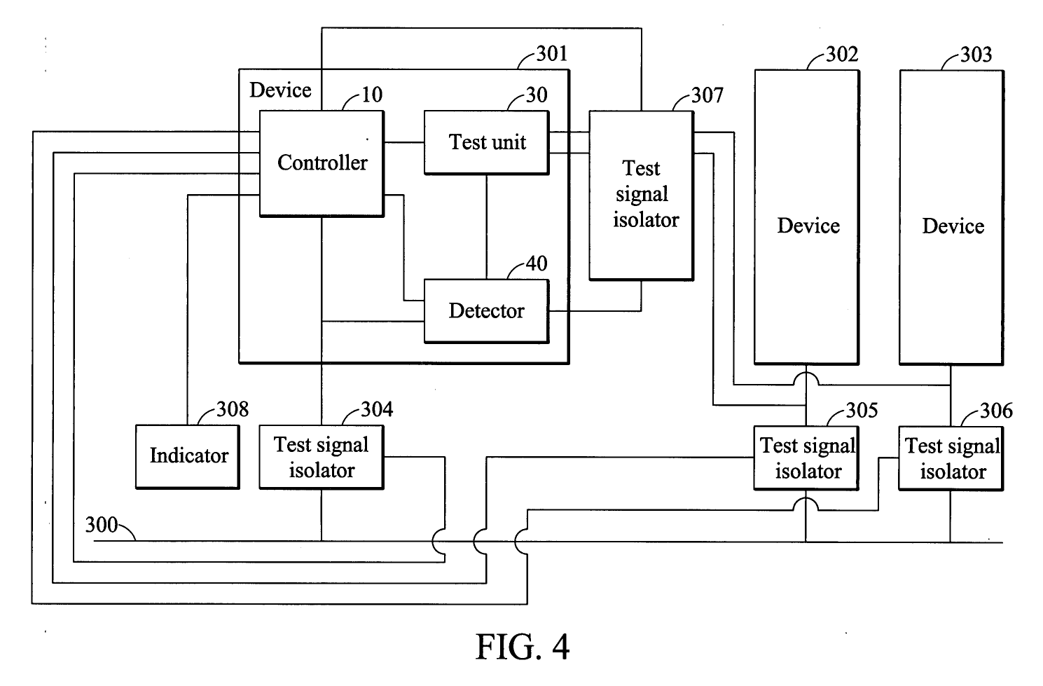

Serial bus 300 in FIG. 4 couples to devices 301-303 through isolators 304-306. Different from the first embodiment, device 301 is a controller assisting in faulty device detection and testing. Device 301 can control isolators 305 and 306 respectively connecting devices 302 and 303, and test devices 302 and 303. Detector 40 is coupled to serial bus 300 through isolator 304. Detector 40 determines if any bus fault has occurred on serial bus 300. Devices 302 and 303 are respectively coupled to serial bus 300 through isolators 305 and 306. Controller 10 is coupled to detector 40, test unit 30, isolators 304-306, and test signal isolator 307. When no bus fault has occurred on serial bus 300, test signal isolator 307 isolates device 301 from devices 302-303. Isolators 304-306 can respectively isolate devices 301-303 from serial bus 300 or couple devices 301-303 thereto.

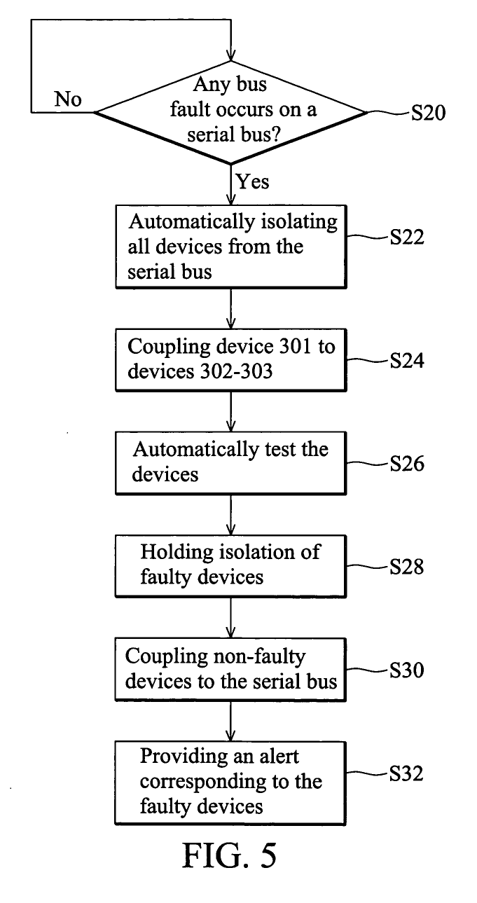

With reference to FIG. 5, detector 40 determines if any bus fault has occurred on serial bus 300 (step S20). When a bus fault occurs on serial bus 300, controller 10 automatically controls isolators 304-306 to isolate devices 301-303 from serial bus 300 (step S22) and directs test signal isolator 307 to couple device 301 to devices 302-303 (step S24).

Test unit 30 tests each of the devices 301-303 (step S26). Testing of devices 301-303 may take place in any order. For example, device 301 may perform a self-test between steps S22 and S24.

When one of the devices 301-303 is a faulty device, controller 10 continues isolating the faulty device (step S28). For example, when device 302 is a faulty device, controller 10 directs isolator 305 to continue isolating device 302 from serial bus 300.

When one of the devices 301-303 is non-faulty, controller 10 couples the non-faulty device to serial bus 300 by controlling an isolator coupled thereto (step S30). For example, when device 303 is proven a non-faulty device, controller 10 couples the device 303 to serial bus 300 utilizing isolator 306 coupled thereto.

Device 301 may be coupled to an indicator, such as indicator 308. When one of devices 301-303 is a faulty device, indicator 308 issues an alert corresponding to the faulty device (step S32). For example, device 301 may notify indicator 308 of the faulty device, and indicator 308 outputs a corresponding alert. Device 301 may also be coupled to a computer system executing a program to provide a corresponding alert in e-mail format. Device 301 may also be coupled to a storage device and executing a program therein to send an alert e-mail.

Note that serial bus 300 may be coupled to a device described in the first embodiment. That is, devices in the first and second embodiments may be coupled to the same bus for cooperation. Additionally, isolators may be integrated in respective devices or a single serial bus.

In conclusion, when a bus fault occurs on a point-to-multipoint bus, devices thereon are automatically isolated, and tested. Connections between non-faulty devices and the serial bus are then recovered. Faulty devices continue to be isolated, and corresponding alerts thereof are provided.

While the invention has been described by way of example and in terms of preferred embodiment, it is to be understood that the invention is not limited thereto. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A method for detecting and isolating serial bus faults, comprising:
detecting if any bus fault has occurred on a serial bus whereon a plurality of devices are respectively coupled thereto through different isolators;
when a bus fault occurs on the serial bus, isolating the devices from the serial bus utilizing the isolators;
testing each of the devices;
when a first device of the devices is non-faulty, controlling an isolator coupled thereto to couple the first device to the serial bus; and
when the first device is faulty, issuing an alert and continuing to isolating the first device.

2. The method as claimed in claim 1, wherein the isolators are controlled by a controller coupled to the serial bus.

3. The method as claimed in claim 2, wherein the controller provides test signals to test the devices.

4. The method as claimed in claim 3, wherein, when no bus fault occurs on the serial bus, the controller is coupled to the serial bus and isolated from one of the devices under test, and, when the bus fault occurs on the serial bus, the controller is isolated from the serial bus and coupled to the one of the devices being tested.

5. A device for detecting and isolating serial bus faults, comprising:
a communication interface coupled to a serial bus through an isolator, and for receiving or transmitting data therethrough;
a detector coupled to the serial bus, determining if any bus fault has occurred on the serial bus;
a controller coupled to the detector and the isolator, when a bus fault occurs on the serial bus, automatically isolating the device from the serial bus utilizing the isolator; and
a test unit coupled to the controller, testing the device, wherein, when the device is non-faulty, the controller couples the device to the serial bus utilizing the isolator, and, when the device is faulty, the controller continues isolating the device.

6. The device as claimed in claim 5, wherein the controller coupled to an indicator providing a corresponding alert when the device is faulty.

7. The device as claimed in claim 5, wherein the serial bus conforms to I²C, SMBus, or IEEE 1394 specification.

8. The device as claimed in claim 5, wherein the isolator may be a reel relay, a solid state relay, a transistor, a bi-directional buffer, or an optical isolator.

9. A device for detecting and isolating serial bus faults, comprising:
a detector coupled to a serial bus, determining if any bus fault occurs on the serial bus whereon a plurality of devices are respectively coupled thereto through different isolators;
a controller coupled to the detector and the isolators, when a bus fault occurs on the serial bus, automatically isolating the devices from the serial bus utilizing the isolators; and
a test unit coupled to the controller, testing each of the devices, wherein, when a first device of the devices is non-faulty, the controller couples the first device to the serial bus utilizing an isolator, and, when the first device is faulty, the controller continues isolating the first device.

10. The device as claimed in claim 9, wherein the test unit couples to the devices through a first isolator, when no bus fault occurs on the serial bus, the first isolator isolates the test unit from the first device, and, when the bus fault occurs on the serial bus, the first isolator couples the test unit to the first device.

11. The device as claimed in claim 9, further comprising an indicator coupled to the controller, providing an alert for the faulty device.

12. The device as claimed in claim 9, wherein the serial bus conforms to I²C, SMBus, or IEEE 1394 specification.

13. The device as claimed in claim 9, wherein the isolator may be a reel relay, a solid state relay, a transistor, a bi-directional buffer, or an optical isolator.

14. The device as claimed in claim 11, wherein the alert comprises an e-mail.
